(19) United States
(12) Patent Application Publication
(10) Pub. No.: US 2018/0072270 A1
(43) Pub. Date: Mar. 15, 2018

(54) VEHICLE SURROUND SECURITY SYSTEM

(71) Applicant: MAGNA ELECTRONICS INC., Auburn Hills, MI (US)

(72) Inventor: Ronald R. Renaud, Oxford, MI (US)

(21) Appl. No.: 15/697,805

(22) Filed: Sep. 7, 2017

Related U.S. Application Data
(60) Provisional application No. 62/385,408, filed on Sep. 9, 2016.

(51) Int. Cl. B60R 25/30; B60R 25/34; B60R 25/104; B60R 25/102; H04N 7/18

(52) U.S. Cl. CPC B60R 25/305; B60R 25/302; B60R 25/34; B60R 2325/205; B60R 25/102; H04N 7/188; H04N 7/181; B60R 25/104

(57) ABSTRACT

A security system for a vehicle includes a plurality of cameras disposed at the vehicle so as to have respective fields of view exterior of the vehicle. A controller is operable to activate at least one of the cameras and to record image data captured by the activated camera responsive to a triggering event indicative of a potential break-in at the vehicle by an intruder. Responsive to the triggering event, the controller activates at least one of the cameras that has a field of view that encompasses a region where the intruder is determined to be present, and does not activate at least one of the cameras that has a field of view that does not encompass the region where the intruder is determined to be present. The triggering event includes touch or movement of a door handle of the vehicle and/or breakage of a window of the vehicle.

### CROSS REFERENCE TO RELATED APPLICATION

The present application claims the filing benefits of U.S. provisional application Ser. No. 62/385,408, filed Sep. 9, 2016, which is hereby incorporated herein by reference in its entirety.

### FIELD OF THE INVENTION

The present invention relates generally to a vehicle security system for a vehicle and, more particularly, to a vehicle security system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more cameras (preferably one or more CMOS cameras) to capture image data representative of images exterior of the vehicle, and provides image capture of areas exterior of the vehicle responsive to an indication of a vehicle break-in, so as to capture images of the thief at the exterior of the vehicle. The camera or cameras may be actuated to begin capturing image data responsive to touch or movement of a door handle of the vehicle and/or a signal indicative of glass breakage of a window of the vehicle and/or the like.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

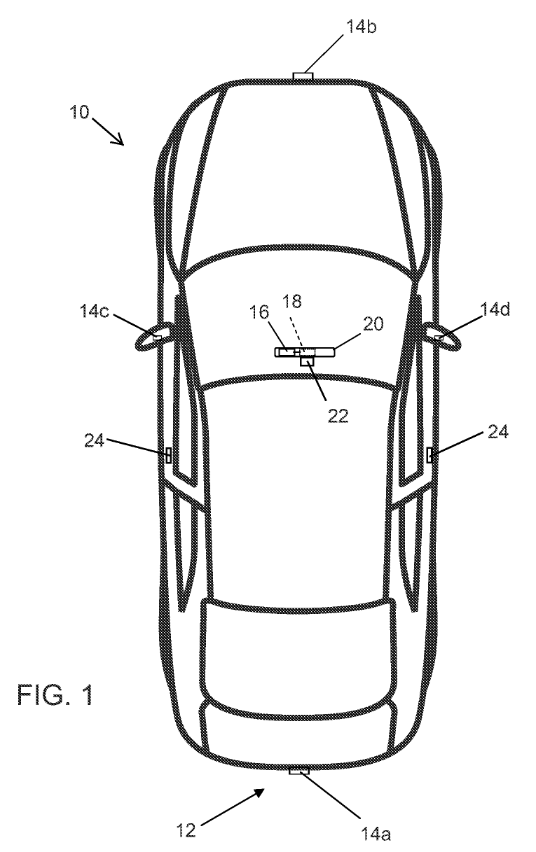

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forward facing camera 14b at the front (or at the windshield) of the vehicle, and a sideward/rearward facing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The system also includes a storage device 22, and the controller is operable to activate one or more cameras 14a-d to capture image data and to store the captured image data at the storage device 22. The controller activates the camera or cameras responsive to a triggering event, such as responsive to one of (i) touch of a door handle 24 of the vehicle (such as responsive to a touch sensor at the vehicle door handle), (ii) movement of a door handle of the vehicle (such as responsive to a motion sensor or position sensor at the vehicle door handle) and (iii) breakage of a window of the vehicle (such as responsive to a window sensor or motion sensor at the window or inside the vehicle).

Everyone has concerns when they leave their vehicle somewhere unattended but locked. A thief may break into the vehicle and steal whatever is inside. To avoid or mitigate such break-ins, the system of the present invention may be able to discourage and/or detour and/or identify the thief, and may be able to contact police and provide an image of the offender, and may also detour/stop the theft entirely with counter measures/activations.

The system involves the use of a surround view camera system by activating and turning on the cameras responsive to the door handles being used (such as responsive to touch or movement at a vehicle door handle) and/or responsive to glass breakage or motion sensing at the vehicle. The door handle is the usual choice for a criminal to try first to see if the car is unlocked. If the door is locked or unlocked, the system would wakeup/turn on and begin its recording of the images available and storing them into the data storage of the vehicle. The door handle activation may have a delay built in so that the owner can unlock the car after touching or moving the door handle (such as via a key fob of the vehicle or by entering a key code or the like), thus stopping the surround security system from activating/recording further.

Responsive to determination of touch or movement of a door handle, the system may actuate one or more of the vehicle cameras to record image data. Optionally, the system may actuate one camera that has its field of view encompassing a region where the intruder is located. For example, responsive to a determination that a potential intruder is at the driver side door (such as responsive to a detected touch or movement of the driver side door handle), the system may activate one or more cameras (such as a driver side camera) having a field of view(s) that encompasses the driver side region of the vehicle. The system may not activate other cameras (such as a forward viewing camera, a rearward viewing camera and a passenger side camera) to limit or reduce the data capture and storage.

The system, responsive to the other activations (glass breakage or motion sensor outputs), may begin to record (such as via one or more exterior cameras and/or one or more interior viewing cameras) immediately upon the sensing (of motion or glass breakage) and record a video of the intrusion. Optionally, the audio/entertainment system may also be activated and may interact with the intruder/criminal by using the infotainment/speaker system to provide a warning, such as, for example, to state in a stern voice “You have entered this vehicle unlawfully; your image is being recorded and sent to the police.” The system would enable the microphones inside of the vehicle to record the audio of the situation. The vehicle's phone system may then be activated to call the police, ONSTAR®, UCONNECT® and/or the like, or any other authority/service, including notifying the driver by his or her cell phone, identifying the location of the vehicle and indicating that video and/or audio have been recorded of the event. Once the driver returns to the vehicle, indicators will appear on the instrument panel information center to alert the driver and indicating or stating that the alarm system was activated and has a recording for the driver to view. The driver can then retrieve the video from the data storage system of the vehicle and place it on a storage device for the police to use (or the stored video/audio recording(s) may be transmitted to the police via a telematics system of the vehicle).

Also, once the surround security vehicle system has been activated and if the thief attempts to steal/start the vehicle unlawfully, the system may deploy counter measures to stop the theft. For example, the system may apply the brakes of the vehicle (such as through the ABS system) or may apply the electric parking brake system to lock the vehicle movement, or the system may not allow the electronic shifter to move out of PARK, or the like, thereby rendering the vehicle stationary. The system may also or otherwise inhibit the starter and ignition to prevent starting of the vehicle engine and/or may activate the vehicle horn and/or lights to alert nearby pedestrians or the like of the ongoing attempted break-in and/or vehicle theft.

The system may detect the presence of a potential thief or intruder using various means. For example, the system may utilize aspects of the systems described in U.S. Pat. Nos. 8,258,932 and/or 6,485,081, and/or U.S. Publication Nos. US-2016-0325681; US-2014-0375476 and/or US-2014-0218529, which are all hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or 4G or 5G) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The system may utilize aspects of head and face recognition systems to recognize and authorize the driver or owner of the vehicle to access the vehicle without triggering an alert. For example, the system may utilize aspects of the systems described in U.S. Publication Nos. US-2016-0137126; US-2015-0352953; US-2015-0296135; US-2015-0294169; US-2015-0232030; US-2015-0022664; US-2015-0015710; US-2015-0009010 and/or US-2014-0336878, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, and may display video images derived from image data captured by the plurality of exterior viewing cameras, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A security system for a vehicle, said security system comprising:
a plurality of cameras disposed at a vehicle, each having a respective field of view exterior of the vehicle, wherein the cameras are operable to capture image data;
a controller operable to activate at least one of the cameras and to record image data captured by the activated camera or cameras responsive to a triggering event indicative of a potential break-in at the vehicle by an intruder;
wherein, responsive to the triggering event, said controller determines the presence of the intruder at a region at or near the vehicle;
wherein, responsive to the triggering event, the controller activates at least one of the cameras that has a field of view that encompasses the region where the intruder is determined to be present;
wherein, responsive to the triggering event, the controller does not activate at least one of the cameras that has a field of view that does not encompass the region where the intruder is determined to be present; and
wherein the triggering event comprises one of (i) touch of a door handle of the vehicle, (ii) movement of a door handle of the vehicle and (iii) breakage of a window of the vehicle.

2. The security system of claim 1, wherein said security system determines the region where the intruder is determined to be present to encompass one of (i) a side region of the vehicle where a door handle of the vehicle is touched or moved, and (ii) a region by a broken window of the vehicle.

3. The security system of claim 1, wherein, responsive to the triggering event, the controller records captured image data on a storage device.

4. The security system of claim 3, wherein, responsive to a signal indicative of remote unlocking of the vehicle door via a remote key fob for the vehicle, the controller stops recording captured image data.

5. The security system of claim 1, wherein, responsive to the triggering event, the controller actuates an audio system of the vehicle to communicate an audible signal to a detected intruder.

6. The security system of claim 1, wherein, responsive to the triggering event, the controller records audio signals received from one or more microphones of the vehicle.

7. The security system of claim 1, wherein, responsive to the triggering event, the controller communicates with a remote device via a communication system of the vehicle, and wherein the remote device comprises a device selected from the group consisting of (i) the vehicle owner's phone, (ii) a device at a police station near the vehicle, (iii) a remote service provider.

8. The security system of claim 1, wherein, responsive to a determination that the driver of the vehicle has returned to the vehicle, the controller generates an alert to the driver to indicate that said security system was activated and that a recording is stored for the driver to view.

9. The security system of claim 1, wherein the plurality of cameras comprises a forward viewing camera disposed at a front portion of the vehicle, a driver side viewing camera disposed at a driver side of the vehicle, a passenger side viewing camera disposed at a passenger side of the vehicle, and a rearward viewing camera disposed at a rear portion of the vehicle.

10. The security system of claim 9, wherein a display system of the vehicle is operable to display video images derived from image data captured by the plurality of cameras to display surround view images for viewing by a driver of the vehicle.

11. A security system for a vehicle, said security system comprising:
a plurality of cameras disposed at a vehicle, wherein the plurality of cameras comprises a front camera disposed at a front portion of the vehicle and having a field of view forward of the vehicle, a driver side camera disposed at a driver side of the vehicle and having a field of view sideward of the vehicle, a passenger side camera disposed at a passenger side of the vehicle and having a field of view sideward of the vehicle, and a rear camera disposed at a rear portion of the vehicle and having a field of view rearward of the vehicle;
wherein the cameras are operable to capture image data;
wherein a display system of the vehicle is operable to display video images derived from image data captured by the plurality of cameras to display surround view images for viewing by a driver of the vehicle;
a controller operable to activate at least one of the cameras and to record image data captured by the activated camera or cameras responsive to a triggering event indicative of a potential break-in at the vehicle by an intruder;
wherein, responsive to the triggering event, said controller determines the presence of the intruder at a region at or near the vehicle;
wherein, responsive to the triggering event, the controller activates at least one of the cameras that has a field of view that encompasses the region where the intruder is determined to be present;
wherein, responsive to the triggering event, the controller does not activate at least one of the cameras that has a field of view that does not encompass the region where the intruder is determined to be present;
wherein the triggering event comprises one of (i) touch of a door handle of the vehicle, (ii) movement of a door handle of the vehicle and (iii) breakage of a window of the vehicle; and
wherein, responsive to the triggering event comprising a touch or movement of a driver side door handle of the vehicle, said controller activates said driver side camera and records image data captured by said driver side camera and does not activate said passenger side camera.

12. The security system of claim 11, wherein said security system determines the region where the intruder is determined to be present to encompass one of (i) a side region of the vehicle where a door handle of the vehicle is touched or moved, and (ii) a region by a broken window of the vehicle.

13. The security system of claim 11, wherein, responsive to the triggering event, the controller records captured image data on a storage device.

14. The security system of claim 13, wherein, responsive to a signal indicative of remote unlocking of the vehicle door via a remote key fob for the vehicle, the controller stops recording captured image data.

15. The security system of claim 11, wherein, responsive to the triggering event, the controller actuates an audio system of the vehicle to communicate an audible signal to a detected intruder.

16. The security system of claim 11, wherein, responsive to the triggering event, the controller records audio signals received from one or more microphones of the vehicle.

17. The security system of claim 11, wherein, responsive to the triggering event, the controller communicates with a remote device via a communication system of the vehicle, and wherein the remote device comprises a device selected from the group consisting of (i) the vehicle owner's phone, (ii) a device at a police station near the vehicle, (iii) a remote service provider.

18. The security system of claim 11, wherein, responsive to a determination that the driver of the vehicle has returned to the vehicle, the controller generates an alert to the driver to indicate that said security system was activated and that a recording is stored for the driver to view.

19. A security system for a vehicle, said security system comprising:
a plurality of cameras disposed at a vehicle, wherein the plurality of cameras comprises a front camera disposed at a front portion of the vehicle and having a field of view forward of the vehicle, a driver side camera disposed at a driver side of the vehicle and having a field of view sideward of the vehicle, a passenger side camera disposed at a passenger side of the vehicle and having a field of view sideward of the vehicle, and a rear camera disposed at a rear portion of the vehicle and having a field of view rearward of the vehicle;
wherein the cameras are operable to capture image data;
wherein a display system of the vehicle is operable to display video images derived from image data captured by the plurality of cameras to display surround view images for viewing by a driver of the vehicle;
a controller operable to activate at least one of the cameras and to record image data captured by the activated camera or cameras responsive to a triggering event indicative of a potential break-in at the vehicle by an intruder;
wherein, responsive to the triggering event, said controller determines the presence of the intruder at a region at or near the vehicle;
wherein, responsive to the triggering event, the controller activates at least one of the cameras that has a field of view that encompasses the region where the intruder is determined to be present;
wherein, responsive to the triggering event, the controller does not activate at least one of the cameras that has a field of view that does not encompass the region where the intruder is determined to be present;
wherein the triggering event comprises one of (i) touch of a door handle of the vehicle, (ii) movement of a door handle of the vehicle and (iii) breakage of a window of the vehicle;
wherein said security system determines the region where the intruder is determined to be present to encompass one of (i) a driver side region of the vehicle where a driver side door handle of the vehicle is touched or moved, (ii) a passenger side region of the vehicle where a passenger side door handle of the vehicle is touched or moved, and (iii) a region by a broken window of the vehicle;
wherein, responsive to the triggering event comprising a touch or movement of a driver side door handle of the vehicle, said controller activates said driver side camera and records image data captured by said driver side camera and does not activate said passenger side camera;
wherein, responsive to the triggering event comprising a touch or movement of a passenger side door handle of the vehicle, said controller activates said passenger side camera and records image data captured by said passenger side camera and does not activate said driver side camera; and
wherein, responsive to a determination that the driver of the vehicle has returned to the vehicle, the controller generates an alert to the driver to indicate that said security system was activated and that a recording is stored for the driver to view.

20. The security system of claim 19, wherein, responsive to the triggering event, the controller actuates an audio system of the vehicle to communicate an audible signal to a detected intruder.
